(19) United States
(12) Patent Application Publication
(10) Pub. No.: US 2018/0104587 A1
(43) Pub. Date: Apr. 19, 2018

(54) VIDEO GAME PLATFORM BASED ON STATE DATA

(71) Applicant: Microsoft Technology Licensing, LLC, Redmond, WA (US)

(72) Inventors: Stephan J. Zachwieja, Redmond, WA (US); Wisgary Francisco Torres Marrero, Bellevue, WA (US); Joaquin Bolbrugge Chavolla, Redmond, WA (US); Scott Nathaniel Munro, Seattle, WA (US); Marcus Michael Powers, Cambridge, MA (US); James Lao, Redmond, WA (US)

(73) Assignee: Microsoft Technology Licensing, LLC, Redmond, WA (US)

(21) Appl. No.: 15/344,379

(22) Filed: Nov. 4, 2016

Related U.S. Application Data
(60) Provisional application No. 62/408,414, filed on Oct. 14, 2016.

(51) Int. Cl. A63F 13/497; A63F 13/86; A63F 13/67

(52) U.S. Cl. CPC A63F 13/497; A63F 13/67; A63F 13/86

(57) ABSTRACT

Systems, methods, and computer media for implementing a video game platform based on video game state data are provided herein. A system can include a processor, a data store, an intake coordinator, and a distribution coordinator. The data store can be configured to store video game state data for different video game play sessions. The intake coordinator can be configured to receive video game state data representing a video game environment over a period of time while a video game is being played by a first user. The video game state data can include frames having time stamps. Some of these frames can be designated as key frames that contain sufficient information to recreate the video game environment at a specific time. A distribution coordinator can be configured to transmit the video game state data to a requesting client, and the requesting client can recreate the video game environment.

### CROSS REFERENCE TO RELATED APPLICATION

This application claims the benefit of U.S. Provisional Application No. 62/408,414, filed on Oct. 14, 2016, and titled “VIDEO GAME PLATFORM BASED ON STATE DATA,” which is incorporated herein by reference in its entirety.

### BACKGROUND

As faster network connections have become commonplace and video games have become more advanced, video games have moved from a local, personal experience to a multiplayer experience in which players in different geographic locations can play together. Even in single player games, players often share recorded or live video streams of a gaming session so that other people can experience what the player experiences. Despite such developments, the ability for different users to be immersed in a gaming session remains limited.

### SUMMARY

Examples described herein relate to a video game platform based on video game state data. An example system can include at least one processor, a data store, an intake coordinator, and a distribution coordinator. The data store can be configured to store video game state data for different video game play sessions. The intake coordinator can be configured to, by the at least one processor, receive first video game state data representing a first video game environment over a period of time while a video game is being played by a first user. Video game state data can include, for example, a location, velocity, color, size, or state of a video game object or a health, level, or experience of a video game character.

The first video game state data can include a plurality of frames having time stamps. Some of these frames can be designated as key frames. Key frames can contain sufficient information to recreate the video game environment at a specific time. A distribution coordinator can be configured to, by the at least one processor, transmit the first video game state data to a requesting client associated with a second user. The first video game state data allows the requesting client to recreate the first video game environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the claimed subject matter will become more apparent from the following detailed description, which proceeds with reference to the accompanying figures.

### BRIEF DESCRIPTION OF THE DRAWINGS

FIG. 1 is a block diagram of an example system capable of implementing a state- based video game platform.

FIG. 2 illustrates an example method of recreating a video game environment via a state-based video game platform.

FIG. 3 illustrates example methods of altering video game state date used to recreate a video game environment.

FIG. 4 illustrates example data flows in an example streaming service implementation.

FIG. 5 illustrates an example method of streaming video game state data using a state- based video game platform.

FIG. 6 illustrates example interactions between different components of an example system implementing a state-based video game platform in which video game state data is streamed from a game client to storage.

FIG. 7 illustrates example interactions between different components of an example system implementing a state-based video game platform in which video game state data is identified through a search and streamed to a game client.

FIG. 8 is a diagram of an example computing system in which some described embodiments can be implemented.

FIG. 9 is an example mobile device that can be used in conjunction with the technologies described herein.

FIG. 10 is an example cloud-supported environment that can be used in conjunction with the technologies described herein.

### DETAILED DESCRIPTION

Using the systems, methods, and computer-readable media described herein, a video game platform can be implemented based on video game state data. Game players can record or live stream video game state data, and the state data can be transmitted to spectators or other players to allow the original player's video game environment to be recreated. Unlike traditional approaches in which a video of the player's gaming session is shared, the video game platforms described herein are based on video game state data that describes the video game environment. State data is a much smaller amount of data than video (especially high definition video, 4K video, etc.), which reduces consumption of bandwidth and can require fewer computing resources to process. Also unlike video data, game state data can include data representing multiple points of view or angles. Spectators can then choose to recreate the video game environment from a point of view different from that of the original player.

A spectator can also add data to the video game state data used to recreate the video game environment. For example, while viewing a gaming session, a user can make annotations such as circling or otherwise indicating a particular aspect of importance in the environment or adding audio commentary or other data. These annotations can be saved either as part of the video game state data or as a separate file or stream and be stored with metadata or other reference to the original stream. In this way, other spectators can access both the original stream and another spectator's annotations.

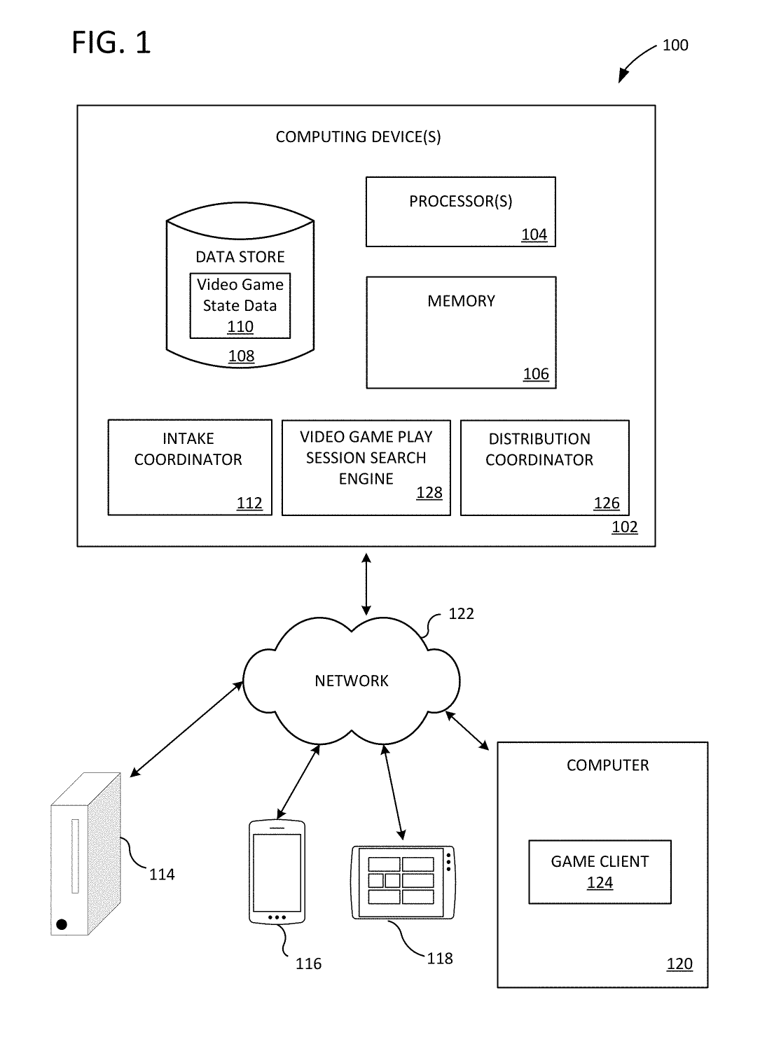

The video game platforms described herein can also be used with different games, can be integrated into game engines, and/or can be implemented as a service. Game developers can designate particular frames in a data stream as key frames, and the platform can facilitate streaming, storage, browsing, and distribution without requiring the game developer to build an infrastructure to accomplish the same. Examples are described below with reference to FIGS. 1-10.

FIG. 1 illustrates a system 100 implemented on one or more computing device(s) 102. Computing device 102 includes at least one processor 104 and memory 106. Computing device 102 can be, for example, one or more server computers, a video game console, or other computing device.

A data store 108 is configured to store video game state data 110 for a plurality of video game play sessions. Data store 108 can be on a single computer or distributed among different computers (e.g., in a cloud computing environment) and can be structured as a database, list, or other format. Video game state data 110 can include state data for video game play sessions for different users and different video games. As used herein, “video game state data” refers to data representing a video game environment from which the video game environment can be recreated and/or updated. Video game state data can include, for example, a location, velocity, color, size, or state of a video game object (e.g., a character, item, road, mountain, building, etc.) or a health, level, or experience of a video game character. Video game state data can also include controller button presses, gestures, or other user input that controls actions in the video game environment as well as game metadata such as a number of players, game mode, etc. The particular video game state data included for specific games can be predetermined and consistent for all game titles or can be determined by the developers of the game title.

Video game state data 110 can comprise a plurality of frames having time stamps or other associated indicators of time. Some of the plurality of frames can be specified in video game state data 110 as key frames. Key frames contain information sufficient to recreate a video game environment at the time corresponding to the key frame. In some examples, the plurality of frames can also include delta frames that represent how the video game environment has changed with respect to a key frame or a previous delta frame. As an example, one key frame may be followed by 10, 100, 1000, or other number of delta frames (which in turn can be followed by another key frame and another series of delta frames). Because a delta frame includes changes with respect to a previous frame, and not all aspects of a video game environment typically change from frame to frame, delta frames typically contain less information than a key frame, preserving bandwidth and processing resources. Key frames, because they contain sufficient information to recreate the video game environment, can be used to recover from errors or losses of connection and serve as points for starting from, skipping forward to, or skipping backward to in a data stream. Key frames can be designated as such with metadata, flags, or other indicators.

In some examples, recreation of the video game environment can take advantage of a game's existing method of environment creation based on state data. That is, a particular game title can use its method of creating a video game environment during actual play based on live data to recreate a game environment in a spectator situation based on video game state data. Methods of video game environment creation can vary from title to title and platform to platform.

The video game environment includes what is seen by a user as the user plays the game. The video game environment can include additional aspects such as portions of the environment that are not seen by the user but are nearby, part of a current level previously or not yet reached, etc. In such cases, the video game state data representing the video game environment can include data representing these additional aspects.

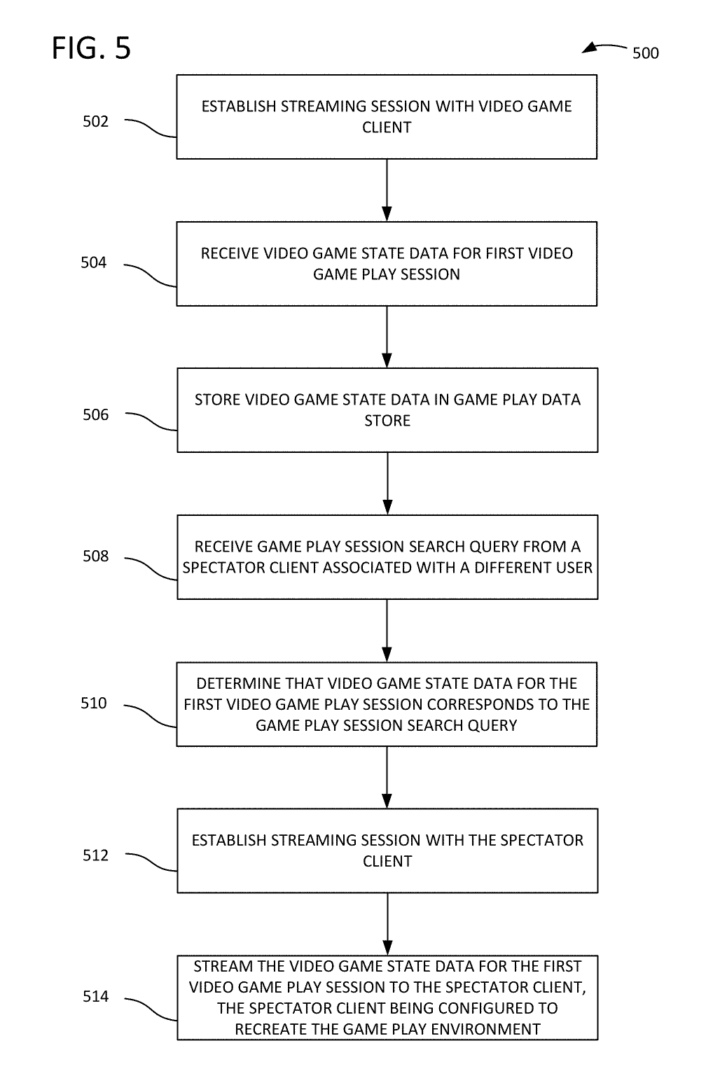

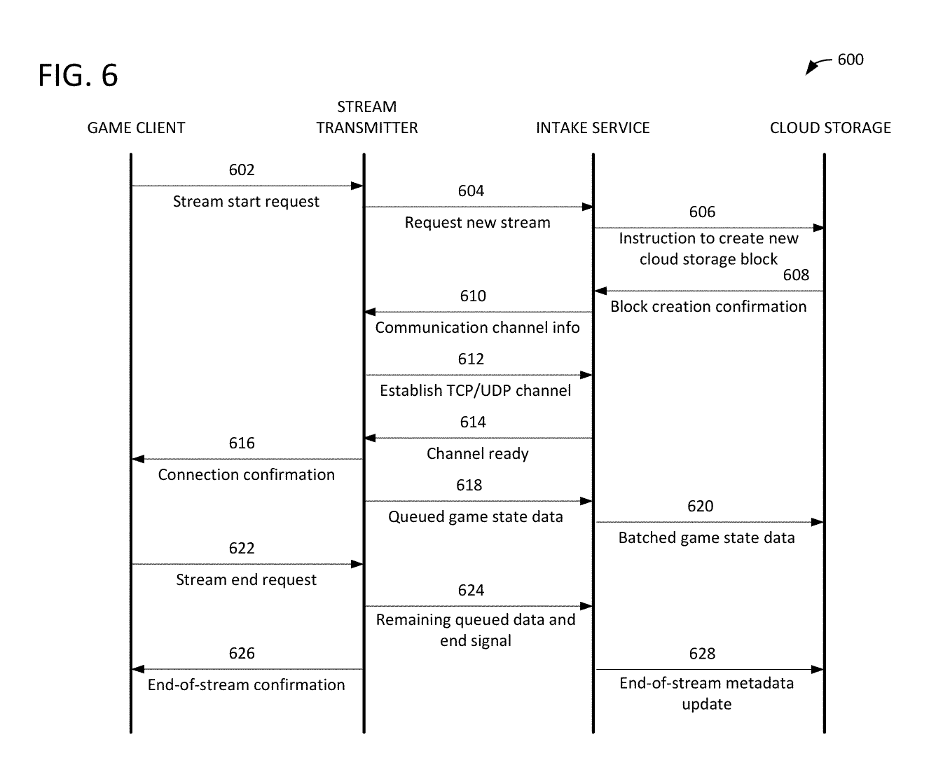

An intake coordinator 112 is configured to, by the at least one processor 104, receive first video game state data representing a first video game environment over a period of time while a video game is being played by a first user. The first user can be playing or have played the video game on video game console 114, smart phone 116, tablet 118, and/or computer 120, which are in communication with intake coordinator 112 via a network 122. Network 122 can be, for example, the Internet. Intake coordinator 112 can be further configured to store the received first video game state data in data store 108. Intake coordinator 112 can receive the first video game state data by communicating with a game client (such as game client 124 on computer 120) on a computing device associated with the first user and establishing, e.g., a transmission control protocol (TCP) or user datagram protocol (UDP) channel between the game client and intake coordinator 112, and then receiving streamed or otherwise communicated data. Operation of example intake coordinators is discussed in detail with respect to FIGS. 5 and 6.

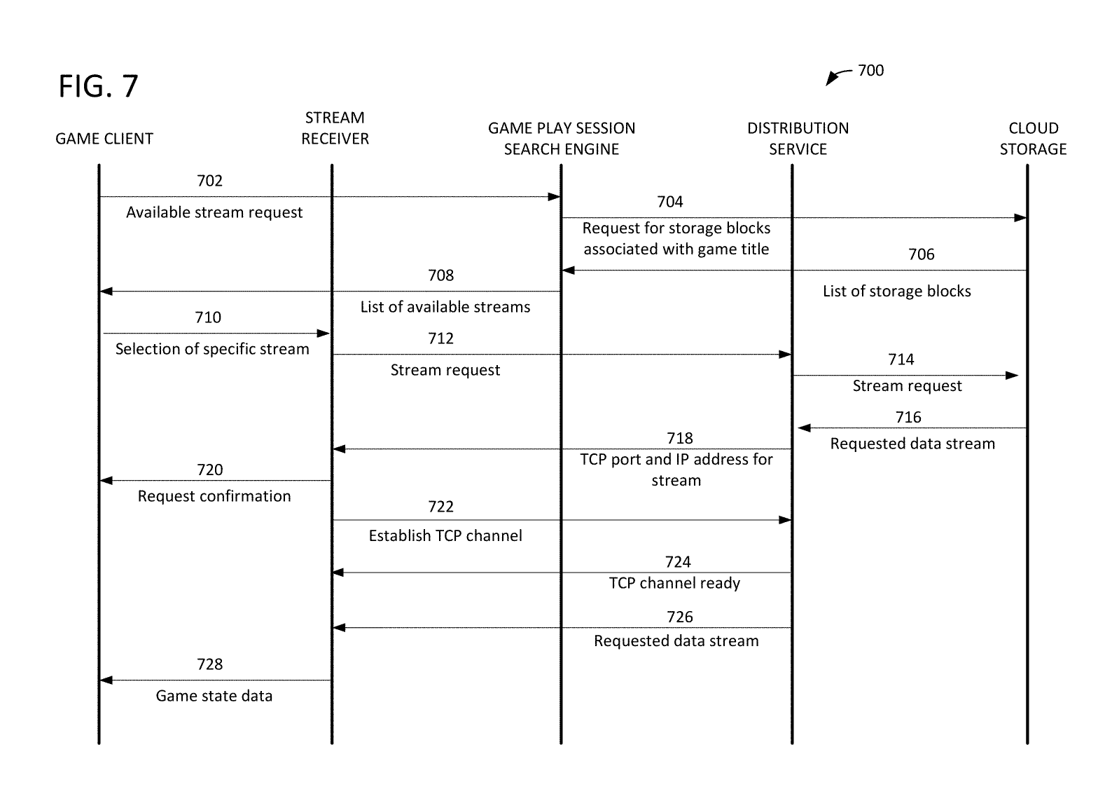

A distribution coordinator 126 is configured to, by the at least one processor 104, transmit the first video game state data to a requesting client (e.g., a game client, such as game client 124) associated with a second user. The first video game state data allows the requesting client to recreate the first video game environment. The requesting client can be implemented as software on a computing device such as video game console 114, smart phone 116, tablet 118, and/or computer 120. In some examples, a requesting client can send a stream request to distribution coordinator 126, and distribution coordinator 126 is configured to establish a TCP or other communication channel between the game client and distribution coordinator 126 by which a stream can be transmitted. Operation of example distribution coordinators is discussed in detail with respect to FIGS. 5 and 7.

In some examples, intake coordinator 112 is configured to receive live (e.g., while a user is playing a game session) streaming game state data for a game session from a game client and store the live streaming data in data store 108. Another game client (requesting client) can submit a request to view the live streaming data and establish a communications channel with distribution coordinator 126. Distribution coordinator 126 is configured to stream the game state data for the game session to the requesting client, allowing a user associated with the requesting client to view a live (or substantially live) stream of the game session. In some examples, game state data can be communicated from intake coordinator 112 to distribution coordinator 126 without being stored first (and, e.g., intake coordinator 112 can also transmit the game state data to data store 108 for other users to view later). In “replay” examples, game state data for a game play session is received and stored, and after the game play session has concluded, another user (or the original game player) requests to replay the session.

In some examples, a user can join a game play session in progress or view a replay and “rewind” to a previous point in the game play session (and also “fast forward” back to the current point in time for a live stream or simply go forward for a replay stream). In such examples, distribution coordinator 126 can be configured to skip backward to a previous key frame and restart the stream from the previous key frame. Similarly, when a user fast forwards, distribution coordinator 126 can be configured to skip forward to a later key frame or (for live streams) wait to execute the fast forward until the next key frame is received.

The requesting client can be or include a spectator client (not shown) that is configured to recreate a game play environment for a video game play session based on the video game state data but is not configured to allow another user to join the game session as an additional player. A spectator client can be, for example, software that is downloaded to support viewing video game play sessions, and the software can interact with distribution coordinator 126 to establish a communications channel and receive a data stream and can use the video game state data to recreate the video game environment.

A spectator client can also be configured to perform annotation of the video game state data based on user input. In such examples, distribution coordinator 126 is configured to, by the at least one processor 104, receive annotated video game state data from the requesting client and communicate the annotated video game state data (or in some examples, only the annotations themselves) to data store 108. In some examples, the requesting client is configured to allow a user to join, as a player, an in-progress game that is being live streamed.

In some examples, a player who is playing a game session can annotate the video game state data. Such annotations can include audio commentary, touch input, or other input. In some examples, a player can select a type of annotation before beginning play or while playing, such as choosing a particular statistic, that would not otherwise be displayed, to be displayed at all times. When another user later views the stream of the game session, the requesting game client can recreate the environment and the displayed statistic.

The requesting client (such as game client 124) can be configured to recreate the first video game environment from multiple points of view, including a point of view different from a point of view experienced by the user playing the game. Video game state data can include enough information about a video game environment that a spectator or player joining a session is not limited to the view of the original player and can select among multiple pre-defined or dynamically determined view angles or points of view. In some examples, multiple “cameras” or view angles are defined in a game, and the video game state data includes data for each camera. In some examples, the coordinate locations of objects in the video game environment are included in the video game state data, and calculations are performed to adjust the recreated video game environment in response to a selected view angle. In some examples, requesting clients viewing a game play session from a different point of view can transmit this alternate view to intake coordinator 112, which can be configured to store the alternate view in data store 108 as a separate game play session. The video game state data for the alternate view and for the original session can be linked in data store 108.

Computing device(s) 102 can also include a video game play session search engine 128, although in some examples, video game play session search engine 128 is omitted. Video game play session search engine 128 is configured to, by the at least one processor 104, receive a search query for video game state data from a requesting client and identify video game state data in the video game state data 110 stored in data store 108 that corresponds to the received query. Video game state data 110, stored in data store 108, can be stored in association with tags or metadata identifying, for example, the game title with which the state data is associated, the user associated with the game session, particular in- game actions (accomplishments, techniques performed, levels completed, etc.) included in the game session, and search queries can specify particular games, users, or actions. Video game play session search engine 128 can also be configured to allow a user to browse a list or other grouping of available streams, which can be organized, for example, by game title or player.

As an example, a requesting client can submit a query to video game play session search engine 128 for available streams for a particular game title. A user associated with the requesting client can then browse the available game play sessions, select a session, and request a stream. Video game play session search engine 128 can communicate the stream request to distribution coordinator 126, or the requesting client can submit the request to distribution coordinator 126. As another example, a requesting client can submit a query to video game play session search engine 128 for available streams corresponding to a particular game title, level being played, experience level of the player, and/or other information, and based on the metadata or tags stored in association with video game state data 110, streams for game play sessions matching the query criteria can be identified, and a stream can be requested.

The video game platforms based on state data described herein can be implemented in a number of ways. In some examples, the platform is implemented as a service, and game clients are provided an endpoint to which data is transmitted or from which data is received. In such examples, a single endpoint can be provided to game clients for communication or different endpoints can be used for intake coordinator 112, distribution coordinator 126, and video game play session search engine 128, which can each be separate services. Data received by intake coordinator 112 via the provided endpoint can be serialized by the time received and stored in data store 108. In some examples, video game platforms can be implemented as a peer-to-peer system in which data store 108, intake coordinator 112, distribution coordinator 126, and video game play session search engine 128 are implemented by a game engine on individual players' game consoles, mobile devices, or computers, and the individual players' game consoles, mobile devices, or computers communicate with each other to distribute/receive game state data.

In some examples, game development kits, which are used by multiple developers to develop game titles for gaming systems, can provide the framework to enable state-data- based video game platforms. For example, a game development kit can prompt or provide an opportunity for a developer to identify key frames.

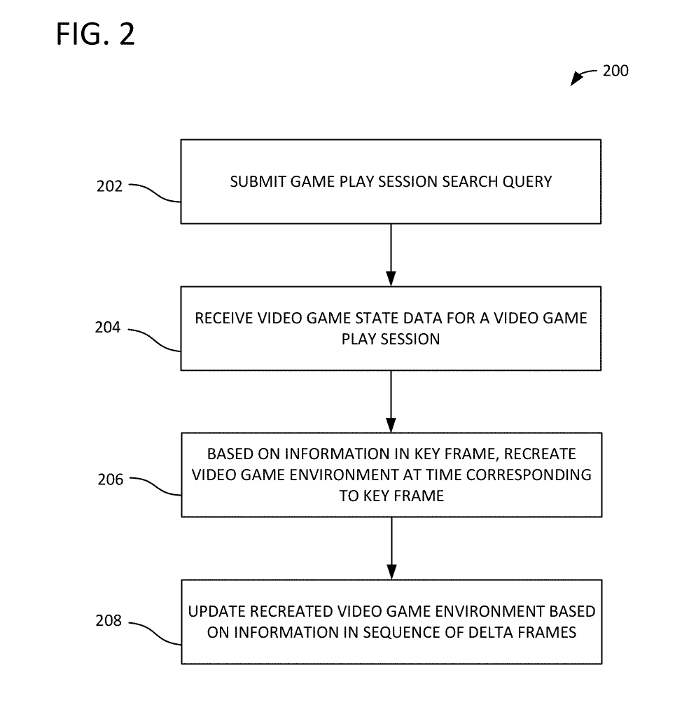

FIG. 2 illustrates a method 200 of recreating a video game environment via a state- based video game platform. In process block 202, a game play session search query is submitted. In process block 204, video game state data for a video game play session corresponding to the game play session search query is received. The video game state data comprises a plurality of time-ordered frames. The plurality of time-ordered frames include a key frame and a plurality of delta frames. The video game state data can be received, for example, from a distribution coordinator or distribution service as discussed with respect to FIG. 1. Based on information contained in the key frame, a video game environment for the video game play session at a time corresponding to the key frame is recreated in process block 206. In process block 208, the recreated video game environment is updated based on information contained in a sequence of the plurality of delta frames. Method 200 can be performed by a requesting client.

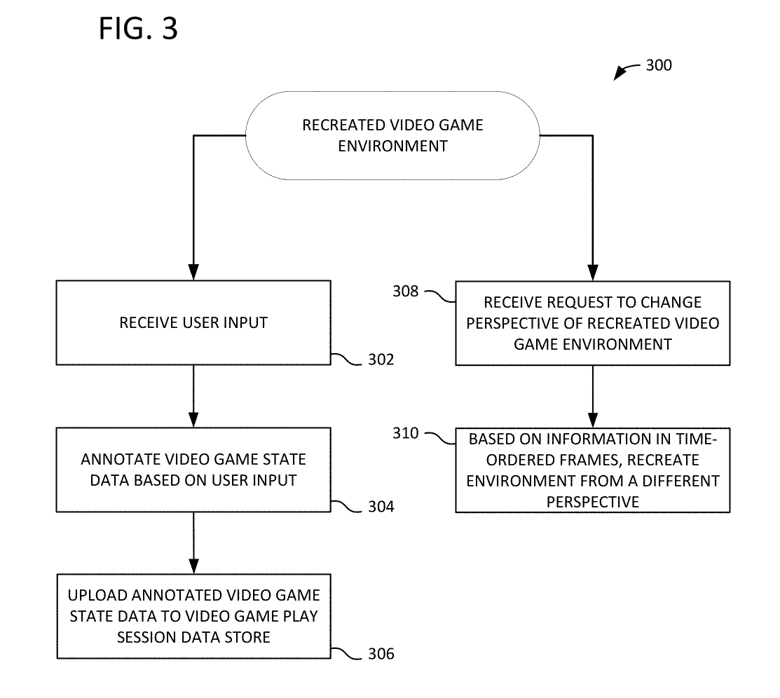

FIG. 3 illustrates a method 300 of performing additional actions at a requesting client after a video game environment has been recreated (e.g., after method 200 of FIG. 2). In process block 302, user input is received. The user input can be audio input, touch input, selection of an object in the recreated game environment, or other input. Video game state data is annotated based on the user input in process block 304. The annotated video game state data is uploaded to a video game play session data store accessible to a plurality of requesting clients in process block 306. In this way, annotated state data can be accessed by other users.

In process block 308, a request to change the perspective of the recreated video game environment is received. Based on the information contained in some of the plurality of time-ordered frames, the video game environment is recreated from a different perspective. In some examples, the video game state data for a game session is recorded and stored from multiple perspectives, and in other examples, coordinate locations of objects are known, and the recreated video game environment is adjusted based on a selected position and view angle. Process blocks 308 and 310 and process blocks 302, 304, and 306 can be performed during a single viewing of a video game session, or only one of the respective groups can be performed.

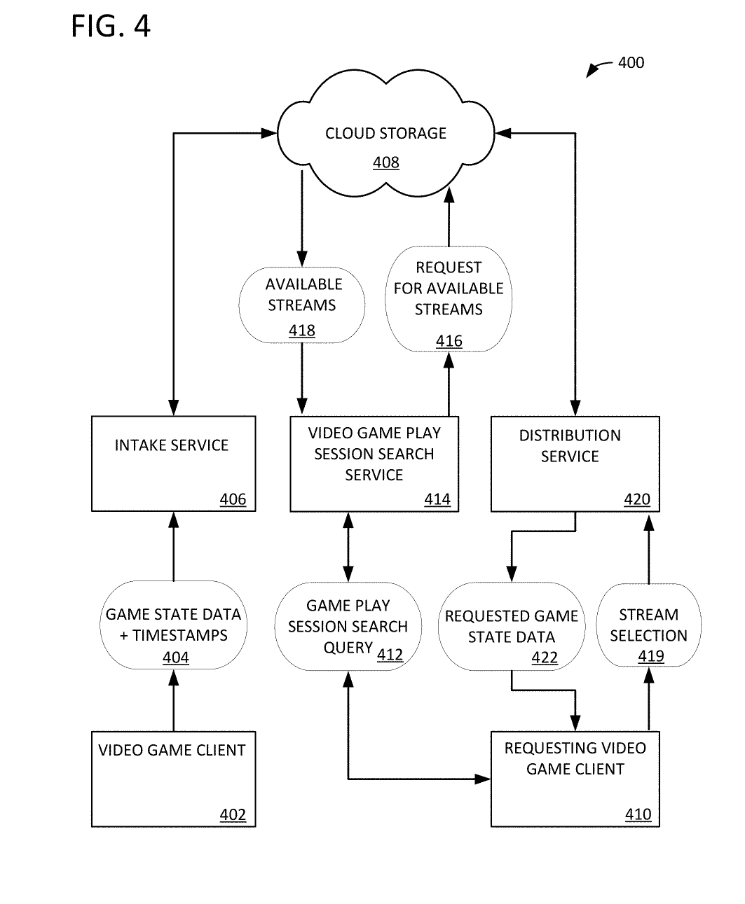

FIG. 4 illustrates an example system 400 in which a video game platform is implemented as a set of web services. A video game client 402 is configured to stream video game state data 404 for a game play session to intake service 406. Video game state data 404 includes timestamps and can be serialized by time either at video game client 402 or intake service 406. Video game client 402 can establish a communication session with intake service 406 based on a known endpoint for intake service 406. Intake service 406 communicates game state data 404 (or a serialized or otherwise processed version of game state data 404) to cloud storage 408.

A requesting video game client 410, which can be a spectator client with limited functionality to join a game or a game client with game play functionality, is configured to submit a game play session search query 412 to a video game play session search service 414. Requesting video game client 410 can establish a communication session with video game play session search service 414 based on a known endpoint for video game play session search service 414, which may be a different endpoint from that used to communicate with intake service 406. Game play session search query 412 can specify a game title, player, in- game action, or other information.

Video game play session search service 414 is configured to submit a request 416 for available streams that correspond to game play session search query 412. Available streams 418 are communicated back to requesting video game client 410. Requesting video game client 410 is configured to submit stream selection 419 for a particular stream to distribution service 420. In some examples, requesting video game client 410 is configured to submit stream selection 419 to video game play session search service 414, which communicates the request to distribution service 420.

Distribution service 420 is configured to stream requested game state data 422 corresponding to the selected stream to requesting video game client 410. Requesting video game client 410 can establish a communication session with distribution service 420 based on a known endpoint for distribution service 420, which may be a different endpoint from that used to communicate with intake service 406 and/or video game play session search service 414. In some examples, a selection of an available stream is transmitted to distribution service 420 rather than video game play session search service 414.

FIG. 5 illustrates a method 500 of streaming video game state data using a state-based video game platform. In process block 502, a streaming session is established with a video game client. In process block 504, video game state data for a first video game play session is received via the streaming session. In process block 506, the video game state data is stored in a game play data store. The game play data store stores video game state data for a plurality of additional video game play sessions received from a plurality of additional video game clients. The additional video game play sessions can be sessions played by different users.

In process block 508, a game play session search query is received from a spectator client. The spectator client and the video game client are associated with different users. In process block 510, it is determined that the video game state data for the first video game play session corresponds to the game play session search query. A streaming session is established with the spectator client in process block 512. The video game state data for the first video game play session is streamed to the spectator client in process block 514. The spectator client is configured to recreate a game play environment for the first video game play session based on the video game state data. The video game state data comprises a plurality of time-ordered frames. The plurality of time-ordered frames includes a plurality of key frames and a plurality of delta frames. The respective key frames contain sufficient information to recreate the video game environment at a point in time, and the respective delta frames representing changes in the video game environment with respect to a key frame or a previous delta frame.

Method 500 can also comprise receiving annotated video game state data for the first video game play session from the spectator client. The annotated video game state data includes information added by a user associated with the spectator client. Method 500 can further comprise storing the annotated video game state data in the game play data store. The annotated video game state data is accessible to additional spectator clients submitting game play session search queries. Streaming sessions can also be established with a plurality of additional spectator clients, and the video game state data for the first video game play session can be streamed to the additional spectator clients.

FIG. 6 illustrates example interactions 600 in a state-based video game platform. A start stream request 602 is transmitted from a game client to a stream transmitter. In some examples, the stream transmitter is part of the game client. The stream transmitter sends a request 604 for a new stream to an intake service. An instruction 606 to create a new cloud storage block is transmitted to the cloud storage. A block creation confirmation 608 is transmitted back to the intake service from cloud storage. Communication channel information 610, which provides information for establishing a communication channel between the stream transmitter and the intake service, is transmitted to the stream transmitter.

The stream transmitter sends a channel establishment message 612 to establish, for example, a TCP or UDP channel with the intake service. The intake service provides a channel ready message 614 back to the stream transmitter. The stream transmitter then provides a connection confirmation 616 to the game client. The stream transmitter streams queued video game state data 618 to the intake service. The intake service batches the received data and transmits batched game state data 620 to cloud storage. At the end of the game play session (or by user request or time-out), the game client sends a stream end request 622 to the stream transmitter. The stream transmitter then transmits the remaining queued data and an end signal 624 to the intake service and sends an end-of-stream confirmation 626 to the game client. Intake service 628 also transmits an end-of-stream metadata update to the cloud storage.

FIG. 7 illustrates example interactions 700 in a state-based video game platform. A game client transmits an available stream request 702 to a game play session search engine. Available stream request 702 specifies the game title and can also specify other information such as in-game actions, players, etc. The game play session search engine transmits a request 704 for storage blocks associated with the game title to cloud storage. A list of storage blocks 706 is transmitted back from cloud storage to the game play session search engine. A list of available streams 708 is transmitted back to the game client from the game play session search engine. A selection 710 of a specific stream is transmitted from the game client to the stream receiver. In some examples, the stream receiver is part of the game client.

The stream receiver transmits a stream request 712 to a distribution service. A forwarded stream request 714 is sent to cloud storage, and a requested data stream 716 is sent back to the distribution service. A TCP port and IP address 718 for a streaming session are transmitted to the stream receiver. A request confirmation 720 is sent from the stream receiver to the game client confirming that the streaming request has been made. A message 722 is sent to the distribution service to establish a TCP channel, and a TCP channel ready message is sent back to the stream receiver. A requested data stream 726 is then transmitted to the stream receiver, and the stream receiver provides the game state data 728 to the game client.

### Example Computing Systems

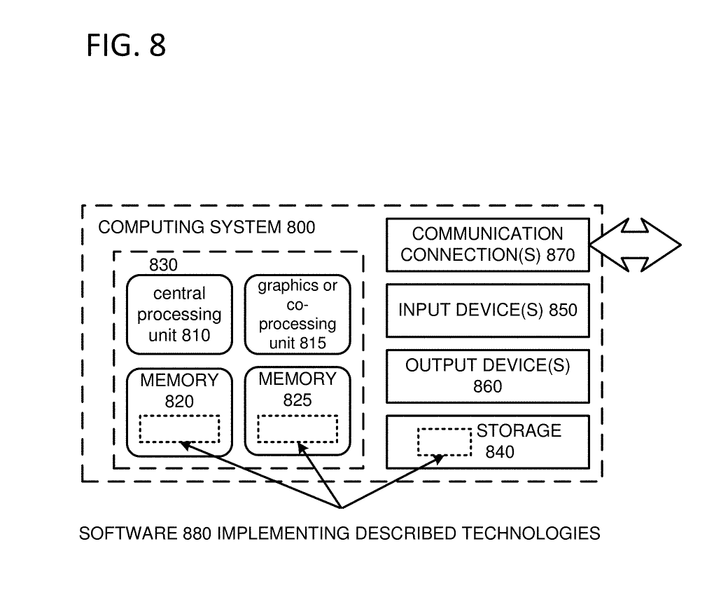

FIG. 8 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s). For example, memory 820, 825 can store intake coordinator 112, video game play session search engine 128, and/or distribution coordinator 126 of FIG. 1.

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information and which can be accessed within the computing system 800. The storage 840 stores instructions for the software 880 implementing one or more innovations described herein. For example, storage 840 can store intake coordinator 112, video game play session search engine 128, and/or distribution coordinator 126 of FIG. 1.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Mobile Devices

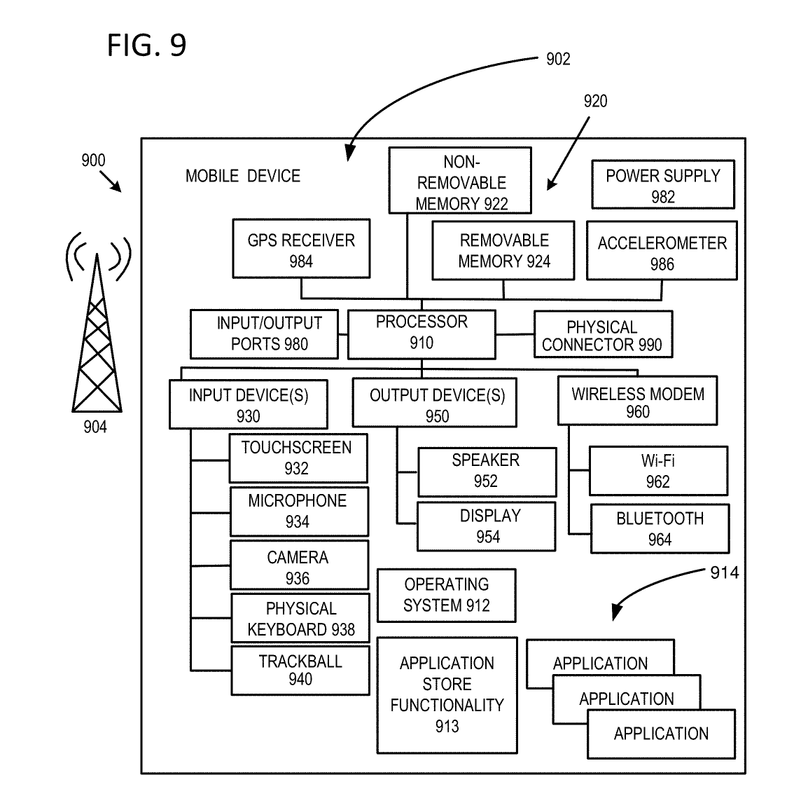

FIG. 9 is a system diagram depicting an example mobile device 900 including a variety of optional hardware and software components, shown generally at 902. Any components 902 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 904, such as a cellular, satellite, or other network.

The illustrated mobile device 900 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components 902 and support for one or more application programs 914. The application programs can include common mobile computing applications (e.g., email applications, calendars, contact managers, web browsers, messaging applications), or any other computing application. The application programs 914 can also include virtual keyboard, task icon, and user interface reconfiguration technology. Functionality 913 for accessing an application store can also be used for acquiring and updating application programs 914.

The illustrated mobile device 900 can include memory 920. Memory 920 can include non-removable memory 922 and/or removable memory 924. The non-removable memory 922 can include RAM, ROM, flash memory, a hard disk, or other well-known memory storage technologies. The removable memory 924 can include flash memory or a Subscriber Identity Module (SIM) card, which is well known in GSM communication systems, or other well-known memory storage technologies, such as “smart cards.” The memory 920 can be used for storing data and/or code for running the operating system 912 and the applications 914. Example data can include web pages, text, images, sound files, video data, or other data sets to be sent to and/or received from one or more network servers or other devices via one or more wired or wireless networks. The memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 900 can support one or more input devices 930, such as a touchscreen 932, microphone 934, camera 936, physical keyboard 938 and/or trackball 940 and one or more output devices 950, such as a speaker 952 and a display 954. Other possible output devices (not shown) can include piezoelectric or other haptic output devices. Some devices can serve more than one input/output function. For example, touchscreen 932 and display 954 can be combined in a single input/output device.

The input devices 930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 can comprise speech-recognition software as part of a voice user interface that allows a user to operate the device 900 via voice commands Further, the device 900 can comprise input devices and software that allows for user interaction via a user's spatial gestures, such as detecting and interpreting gestures to provide input to a gaming application.

A wireless modem 960 can be coupled to an antenna (not shown) and can support two-way communications between the processor 910 and external devices, as is well understood in the art. The modem 960 is shown generically and can include a cellular modem for communicating with the mobile communication network 904 and/or other radio-based modems (e.g., Bluetooth 964 or Wi-Fi 962). The wireless modem 960 is typically configured for communication with one or more cellular networks, such as a GSM network for data and voice communications within a single cellular network, between cellular networks, or between the mobile device and a public switched telephone network (PSTN).

The mobile device can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components 902 are not required or all-inclusive, as any components can be deleted and other components can be added.

### Example Cloud-Supported Environments

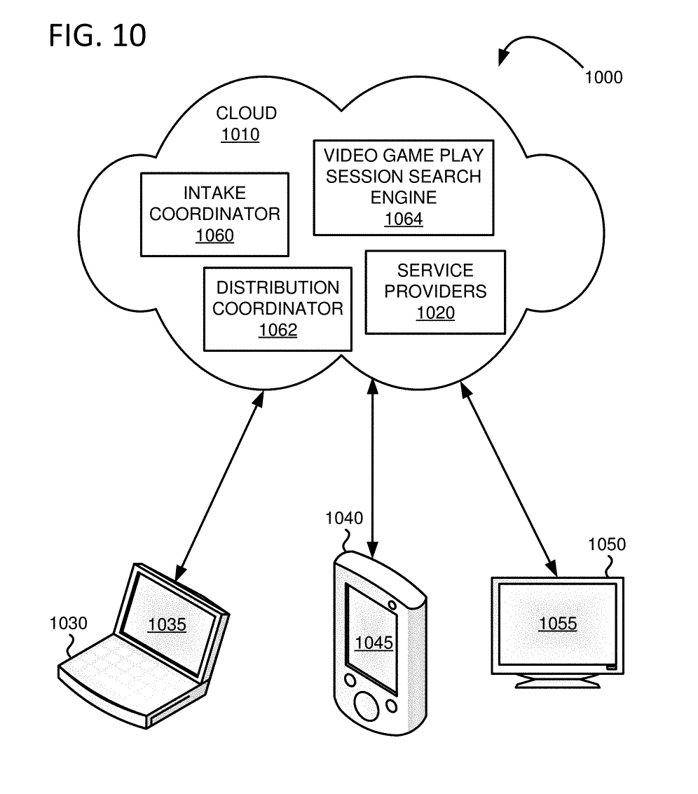

FIG. 10 illustrates a generalized example of a suitable cloud-supported environment 1000 in which described embodiments, techniques, and technologies may be implemented. In the example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050) while other tasks (e.g., storage of data to be used in subsequent processing) can be performed in the cloud 1010.

In example environment 1000, the cloud 1010 provides services for connected devices 1030, 1040, 1050 with a variety of screen capabilities. Connected device 1030 represents a device with a computer screen 1035 (e.g., a mid-size screen). For example, connected device 1030 can be a personal computer such as desktop computer, laptop, notebook, netbook, or the like. Connected device 1040 represents a device with a mobile device screen 1045 (e.g., a small size screen). For example, connected device 1040 can be a mobile phone, smart phone, personal digital assistant, tablet computer, and the like. Connected device 1050 represents a device with a large screen 1055. For example, connected device 1050 can be a television screen (e.g., a smart television) or another device connected to a television (e.g., a set-top box or gaming console) or the like. One or more of the connected devices 1030, 1040, 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Services can be provided by the cloud 1010 through service providers 1020, or through other providers of online services (not depicted). For example, cloud services can be customized to the screen size, display capability, and/or touchscreen capability of a particular connected device (e.g., connected devices 1030, 1040, 1050).

In example environment 1000, the cloud 1010 provides the technologies and solutions described herein to the various connected devices 1030, 1040, 1050 using, at least in part, the service providers 1020. For example, the service providers 1020 can provide a centralized solution for various cloud-based services. The service providers 1020 can manage service subscriptions for users and/or devices (e.g., for the connected devices 1030, 1040, 1050 and/or their respective users). The cloud 1010 can implement an intake coordinator 1060, a distribution coordinator 1062, and a video game play session search engine 1064, which can be similar to intake coordinator 112 of FIG. 1, distribution coordinator 126 of FIG. 1, and video game play session search engine 128 of FIG. 1.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 8, computer-readable storage media include memory 820 and 825 and storage 840. By way of example and with reference to FIG. 9, computer-readable storage media include memory 920, 922, and 924. The term computer-readable storage media does not include signals and carrier waves. In addition, the term computer-readable storage media does not include communication connections (e.g., 870, 960, 962, and 964).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. A system, comprising:
at least one processor;
a data store configured to store video game state data for a plurality of video game play sessions;
an intake coordinator configured to, by the at least one processor, receive first video game state data representing a first video game environment over a period of time while a video game is being played by a first user, wherein the first video game state data comprises a plurality of frames having time stamps, and wherein the first video game state data specifies some of the plurality of frames as key frames; and
a distribution coordinator configured to, by the at least one processor, transmit the first video game state data to a requesting client associated with a second user, wherein the first video game state data allows the requesting client to recreate the first video game environment.

2. The system of claim 1, wherein the respective individual key frames contain sufficient information to recreate the first video game environment at the time corresponding to the key frame.

3. The system of claim 1, wherein the plurality of frames further comprises a plurality of delta frames, and wherein the respective delta frames represent how the video game environment has changed with respect to a key frame or a previous delta frame.

4. The system of claim 1, wherein the first video game state data comprises at least one of a location, velocity, color, size, or state of a video game object or a health, level, or experience of a video game character.

5. The system of claim 1, wherein the system is a streaming service system, wherein the intake coordinator is configured to, by the at least one processor, receive the first video game state data as a stream, and wherein the distribution coordinator is configured to, by the at least one processor, stream the first video game state data to the requesting client.

6. The system of claim 5, wherein the intake coordinator is configured to, by the at least one processor, receive the first video game state data as a stream while the first user is playing the video game.

7. The system of claim 6, wherein the distribution coordinator is configured to, by the at least one processor, stream the first video game state data to the requesting client while the first user is playing the video game or stream the first video game data to the requesting client after the first user has finished playing the video game.

8. The system of claim 1, wherein the requesting client is configured to recreate the first video game environment from multiple points of view, including a point of view different from a point of view experienced by the first user while the first user was playing the game.

9. The system of claim 1, wherein the requesting client comprises a video game spectator client configured to recreate the first video game environment but not configured to allow play of the video game.

10. The system of claim 1, wherein the distribution coordinator is configured to, by the at least one processor, receive annotated first video game state data from the requesting client, wherein the annotated first video game state data includes annotations made to the received first video game state data by the requesting client.

11. The system of claim 1, wherein the video game state data for the plurality of video game play sessions is for a plurality of users and a plurality of video games.

12. The system of claim 1, further comprising:
a video game play session search engine configured to, by the at least one processor:
receive a search query for video game state data from the requesting client associated with the second user; and
identify the first video game state data as corresponding to the received query.

13. The system of claim 12, wherein the search query specifies one or more in- game actions, and wherein the first video game state data comprises an indication that the one or more in-game actions are represented by the first video game state data.

14. One or more computer-readable memory or storage devices having stored thereon computer-executable instructions to cause a computer system, when programmed thereby, to perform operations comprising:
submitting a game play session search query;
receiving video game state data for a video game play session corresponding to the game play session search query, the video game state data comprising a plurality of time-ordered frames, the plurality of time-ordered frames including a key frame and a plurality of delta frames;
based on information contained in the key frame, recreating a video game environment for the video game play session at a time corresponding to the key frame; and
updating the recreated video game environment based on information contained in a sequence of the plurality of delta frames.

15. The one or more computer-readable memory or storage devices of claim 14, wherein the operations further comprise:
receiving a request to change the perspective of the recreated video game environment; and
based on the information contained in some of the plurality of time-ordered frames, recreating the video game environment from a different perspective.

16. The one or more computer-readable memory or storage devices of claim 14, wherein the operations further comprise:
receiving user input;
annotating the video game state data based on the user input; and
uploading the annotated video game state data to a video game play session data store accessible to a plurality of requesting clients.

17. The one or more computer-readable memory or storage devices of claim 14, wherein recreating the video game environment is performed while additional data for the video game play session is being generated.

18. A method, comprising:
establishing a streaming session with a video game client;
receiving, via the streaming session, video game state data for a first video game play session;
storing the video game state data in a game play data store, the game play data store storing video game state data for a plurality of additional video game play sessions received from a plurality of additional video game clients;
receiving a game play session search query from a spectator client, wherein the spectator client and the video game client are associated with different users;
determining that the video game state data for the first video game play session corresponds to the game play session search query;
establishing a streaming session with the spectator client; and
streaming the video game state data for the first video game play session to the spectator client, wherein the spectator client is configured to recreate a game play environment for the first video game play session based on the video game state data, wherein the video game state data comprises a plurality of time-ordered frames, and wherein the plurality of time-ordered frames includes a plurality of key frames and a plurality of delta frames, the respective key frames containing sufficient information to recreate the video game environment at a point in time, and the respective delta frames representing changes in the video game environment with respect to a key frame or a previous delta frame.

19. The method of claim 18, further comprising: receiving annotated video game state data for the first video game play session from the spectator client, wherein the annotated video game state data includes information added by a user associated with the spectator client; and storing the annotated video game state data in the game play data store, wherein the annotated video game state data is accessible to additional spectator clients submitting game play session search queries.

20. The method of claim 18, further comprising: establishing streaming sessions with a plurality of additional spectator clients; and streaming the video game state data for the first video game play session to the additional spectator clients.
